(19) United States
(12) Patent Application Publication
(10) Pub. No.: US 2017/0228821 A1
(43) Pub. Date: Aug. 10, 2017

(54) SYSTEM AND METHOD FOR SELF-AGGREGATING, STANDARDIZING, SHARING AND VALIDATING CREDIT DATA BETWEEN BUSINESSES AND CREDITORS

(71) Applicant: Descant, Inc., Portland, OR (US)

(72) Inventor: LaVonne Reimer, Portland, OR (US)

(73) Assignee: Descant, Inc., Portland, OR (US)

(21) Appl. No.: 15/472,155

(22) Filed: Mar. 28, 2017

Related U.S. Application Data
(63) Continuation-in-part of application No. 14/189,826, filed on Feb. 25, 2014.
(60) Provisional application No. 61/769,101, filed on Feb. 25, 2013.

(51) Int. Cl. G06Q 40/02; G06F 21/62; G06N 99/00; G06Q 40/00; G06F 17/30

(52) U.S. Cl. CPC G06Q 40/025; G06Q 40/12; G06F 17/30371; G06N 99/005; G06F 21/6218

(57) ABSTRACT

A system and method for assisting firms enter, format, and validate their financial data with their creditors easily, with greater integrity and greater transparency in credit practices. The system allows for input of a firms financial data, formatting that data into industry standard business format, and allow for secure sharing of that information between businesses, partners and creditors. The system maps idiosyncratic data representations and similar forms of semi-structured data to a single standard taxonomy, allows users to improve and approve the mapping, and learns from those users' actions to improve the fidelity of the translation over time. The system uses a firms' own actions on a financial data sharing site to establish a measure of their data's integrity, accuracy, and trustworthiness.

### CROSS-REFERENCE TO RELATED APPLICATION

This application is a continuation-in-part of co-pending U.S. patent application Ser. No. 14/189,826, filed on Feb. 25, 2014, which claims priority to U.S. Provisional Application Ser. No. 61/769,101 filed Feb. 25, 2013, and is incorporated herein by reference in its entirety.

### FIELD

The system and method disclosed generally relates to translating, normalizing, sharing, and validating similarly-structured data input by a plurality of non-expert users.

### BACKGROUND

Systems that directly or indirectly touch on data used in verifying the soundness of privately held firms apply methods for collecting and analyzing such data intermediate the flow of many-to-many exchanges or enable direct exchanges involving one-to-many or many-to-one. The underlying limitation is the absence of systems and methods to make such data machine readable at scale.

Organizations (creditors) doing business with privately held firms must verify the soundness of each firm and its ability to honor the conditions of the credit agreement. The data that creditors find most probative of such ability, such as financial reports, is non-standard in format and viewed by each firm as confidential information. The systems by which such verification is supplied are constrained by the degree to which credit information is hard to gather and share. The only known methods for verifying the data were through an intermediary such as a credit bureau and manual intake and review by each specific creditor. As new forms of networks and cloud-based systems have emerged, these known methods have continued to define data collection and analysis for privately-held firms.

For trade credit decisions—intermediary-supplied scores or profiles—are generally viewed by creditors as sufficient but firms are not able to easily review and correct flawed inputs and outputs nor are they able to manage and control how such data are supplied to creditors. Further, firms have little or no recourse with the intermediary and/or provider of credit in the event erroneous outputs result in undeserved or wrongly denied trade credit terms.

For credit decisions based on big data and machine learning systems, typically alternative online financing and loans, firms may authorize data under their control to be collected but often do not have visibility to other publicly available data aggregated by such systems and/or data for purchase from data brokers. Further, the analytical processes of such systems are complex and difficult for many credit analysts, much less the owner or principal of a small firm to understand. These systems represent an emerging sector of commercial credit that, in practical effect, carries forward the opaque nature of credit bureaus specifically and commercial credit generally. That is, there is little or no visibility, reusability, and recourse much less ability to benefit from the collective value that flows from many similar firms also seeking and accessing credit.

For credit decisions involving disbursement of money, such as bank loans and customer procurement, the legacy system and methods—credit bureau supplied scores—are insufficient. These decisions are based on the creditor's ability to evaluate and continuously monitor the essential business and financial data of the firm. Firms will not provide confidential business and financial data to a credit bureau because they cannot control who sees that data nor can they direct such data to desired organizations for credit reviews. The burden to supply such data directly to creditors falls on each firm.

For privately held firms, many of which are small- and mid-sized businesses (SMBs), the process of supplying and analyzing information that includes data such as financial reports causes errors, delays, and limited visibility along the entire process. Financial data for SMBs are highly non-standard. Presently, each firm manually edits financial reports via spreadsheets that are often transmitted by fax where they are manually re-keyed into creditor systems.

Privately held firms encounter the problem of non-standard financial data every time they must supply proof of the soundness of their business and their ability to honor the conditions of agreements with major creditors such as their lenders, investors and customers. Such proof is typically required at the initial evaluation and periodically over the term of the agreement and/or life of the commercial relationship. Either the firm supplying or organizations receiving the data (often both) must manually normalize the supplied data to a standard taxonomy. This creates additional friction in SMB access to bank loans and similar financing as well as procurement approvals for enterprise and government sales.

Firms in the SMB market often do not have Chief Financial Officers or staff with sufficient skills to understand the best way to edit and present financial data to their creditors. In many cases, they hire outside consultants to prepare data and reports or the Chief Executive Officer (CEO) or other senior executive does the work. Because creditors such as banks and procurement departments require periodic reports and updates, either option creates a significant operating expense for the firm.

In addition, the multiple manual steps along the credit reporting process introduce a high risk of errors. Furthermore, this process, whether conducted with a regulated creditor such as a commercial bank or an unregulated creditor such as an enterprise procurement department, makes it difficult for firms to detect material errors that prevent them from securing favorable deals and result in lost opportunities.

The off-line nature of a manual process limits visibility for both the firm being evaluated and the creditor. The firm cannot easily determine whether, when and by whom their data are viewed as well as how they are being evaluated. Creditors cannot easily monitor such firms in a manner that would help them identify new opportunities, provide meaningful counsel, and mitigate risk exposure.

With publicly traded firms, the Securities and Exchange Commission is in a position to drive standardization in formats used to report business and financial data. There is no such regulatory body or standard for the privately held firms in the SMB market. The absence of a central body or standard along with variations in business models, level of financial expertise, and accounting software make SMB financial data uniquely non-standard. While some major creditors have attempted to impose financial data formats on the SMB market, the market's fragmentation and pervasive lack of resources undercut compliance.

Prior attempts to automate the process of translating and normalizing the data of small privately held firms have incurred very high error rates because of the high degree of variability in how each firm structures its data, the quantity of small privately held firms, and significant diversity in categories, products and services, and business models in the small business market.

Organizations attempting to do business with privately held firms incur added costs and delays in gathering credit information about and from the firms. Additional impacts include high loan break-even, making it difficult if not impossible to meet the financing requirements of smaller firms. Further, each such organization stores data received by its small firm clients or borrowers on its fire-wall protected servers making such data inaccessible to firms that may want to re-use it with other creditors. This standard practice precludes sharing data for collective analysis that would be of great value to each firm and also creditors.

Privately held firms and their creditors face substantially similar challenges with non-financial data that they manage through software providers or in spreadsheets and track over time and that would add context of significance to the firm and also to organizations that evaluate and monitor them. These data, such as operational metrics, enterprise resource management, parts and inventory, point of sales, ecommerce purchases and shipments, and environmental or social impact reports, present in formats similar to financial reports. That is, row headers are expressed in text that defines the remaining numbers in the row and column headers are expressed in a variety of date formats associating a time period such as a month or quarter with the numbers in the column below.

In essence what is required is a system and method for small and medium businesses, SMBs, that makes financial, and similarly semi-structured non-financial, data machine readable for the purpose of easily, securely, and directly sharing data, according to credit industry accepted standards, with their major creditors including lenders, partners, and other financial stakeholders while meeting creditor requirements of independent verification.

### SUMMARY

The system and method disclosed leverage cloud-based architectures and the commercial relationships among firms and their respective creditors to streamline credit reporting and greatly improve data quality and fidelity. It allows firms to directly share credit information with organizations evaluating and monitoring them with no need for intermediaries or intervening manual data entry. Firms use a graphical user interface comprised of elements that, when triggered, signal and/or train the underlying interactive machine learning system to render their financial and similarly semi-structured non-financial data machine readable and thereby possible to easily and selectively share with creditors. Data can be easily uploaded and/or synced by action of the firm's owner or principal, from cloud-based data services, auto-standardized, kept up to date, and shared repeatedly with as many creditors as needed. The disclosed system ingests data and captures explicit and implicit actions of the participants in these commercial relationships to aid analysis, normalization, and verification. Business users view their own firm's data in the context that will be seen by creditors, all to deliver new value to them for having provided data quantity and quality. Creditors make credit decisions that are more transparent, collaborative and consistent, all to improve their understanding of each business, optimize returns, and mitigate risk.

The present application discloses a method that allows firms to use the disclosed cloud-based system to share their business and financial data with their creditors with a minimum of effort. The disclosed system parses supplied data, typically originating in a summary report, to discrete data objects and attempts to map each such object to a schema comprised of common taxonomy of categories and sub-categories. The data are restructured according to suggested mapping and presented to the user in a graphical user interface that makes it easy for the user to review and modify suggested mapping as well as train the underlying mapping system. The mapped categories are shown as “tags” or text labels that are shown next to the user's original labels. The user is able to move these tags to other rows of data, remove them, or add additional tags. If a suitable tag is not found the user can suggest a new tag. When users are satisfied with the mapping defined by the application of the tags, they submit that mapping to the system. Mapping from the previous session is preserved; obviating the need to repeat the mapping exercise when the user uploads additional data or the system auto-updates data unless something has changed in the way the firm is representing its financial performance. Additionally, the disclosed system aggregates tag mappings from all sessions and uses them to inform the initial parsing and mapping of data from new users. In this way, the system continuously learns from all user activity, improving its ability to parse and map new data and reducing the amount of review and modification needed by subsequent users. Over time, standards will organically emerge that can take arbitrary financial and non-financial data from any given firm and automatically map them to such standard taxonomies.

The presently disclosed system and method provides firms with visibility and control in credit evaluation and monitoring activities that are not available or are costly and difficult in a manual process. This makes them willing suppliers of confidential data that is not easily available to creditors or through credit bureaus today. Firms may create unique views of their data for an unlimited number of stakeholders by choosing access rights auto-generated by the system or configuring new views in a fine-grained manner. New and modified visualizations of data such as financial reports and reports may be generated for immediate and selective or generalized publication with no additional programming required. Firms may grant creditors continuous visibility to financial performance and creditworthiness in an automated manner. Furthermore, the pooling of data for comparative views are optimized and anonymized to permit access by any user without disclosing identifying information of the specific entities that contributed to the aggregates while supporting meaningful and fair comparisons.

The presently disclosed system and method establishes the validity and accuracy of user-supplied data through contextual and social information derived from the activities associated with the data as captured through interactions with a set of elements in the graphical user interface rather than by solely auditing the data itself. By observing and analyzing such activities of the firm that owns the data and the other users invited by the firm to observe and interact around the data, the system and method can infer degrees of accuracy and trustworthiness to the data itself. Creditors can be provided this analysis in a graphical user interface that makes credit decisions quicker and more accurate and obviates the need for a credit bureau to intermediate the exchange. This further addresses business and regulatory requirements that the bases for credit decisions and evaluations be independently verified.

These and other features of the invention will be more readily understood upon consideration of the attached drawings and of the following detailed description of those drawings and the presently-preferred and other embodiments of the invention.

### BRIEF DESCRIPTION OF THE DRAWINGS

FIG. 1 illustrates the basic system architecture.

FIG. 2A illustrates the interface for creating groups for the sharing of the financial data. FIG. 2B illustrates another embodiment of the interface design.

FIG. 3A illustrates the interface by which a firm invites a creditor to a private group the user created. FIG. 3B illustrates another embodiment of the interface design.

FIG. 4A illustrates collaboration between a firm and a creditor who is invited by a firm to view their data. FIG. 4B illustrates another embodiment of the interface design.

FIG. 5A illustrates the interface that allows a user to upload his or her firm's financial data. FIG. 5B illustrates another embodiment of the interface design.

FIG. 6 illustrates the initial review screen that allows the user to ensure his or her firm's data have been properly uploaded.

FIG. 7A illustrates the screen where a user is shown the parsed, uploaded data and is able to adjust initial mapping through the use of “tags.” FIG. 7B illustrates another embodiment of the interface design.

FIG. 8 illustrates the interface for viewing activities of the kind that are observed and analyzed for trust assessment.

FIG. 9 illustrates an embodiment of the claimed method related to inputs and activities by a non-expert user.

FIG. 10 illustrates another embodiment of the claimed method related to assignment of attributes.

FIG. 11 illustrates another embodiment of the claimed method related to association of contextual and social information.

FIG. 12 illustrates another embodiment of the claimed method related to identifying and non-identifying attributes.

FIG. 13 illustrates the interface for viewing activities of the kind that are observed and analyzed for data fidelity assessment.

FIG. 14 illustrates the interactive application architecture for inferring data fidelity.

FIG. 15 illustrates the interactive application architecture for user contributions to normalize user supplied data.

FIG. 16 illustrates a comparison of the interactive application architecture with a non-interactive application architecture.

FIG. 17 illustrates the interactive application architecture.

FIG. 18 illustrates the interactive application architecture related to contextual and social information.

FIG. 19 illustrates the interactive application architecture related to translation and normalization.

FIG. 20 illustrates the interactive application architecture related to data fidelity assurance.

FIG. 21 illustrates the interactive application architecture related to non-expert contributed schema publication.

FIG. 22 illustrates attribute schema publication workflow.

FIG. 23 illustrates the interface for defining a schema.

FIG. 24 illustrates the graphical user interface for creating and organizing categories within a taxonomy.

FIG. 25 illustrates the graphical user interface for creating and publishing schema-related access controls.

FIG. 26 illustrates the graphical user interface for creating and publishing schema-related metrics.

FIG. 27 illustrates the graphical user interface for creating and publishing schema-related metrics.

FIG. 28 illustrates the graphical user interface for creating and publishing schema-related report displays.

It should be noted that the figures are not drawn to scale and that elements of similar structures or functions are generally represented by like reference numerals for illustrative purposes throughout the figures. It also should be noted that the figures are only intended to facilitate the description of the preferred embodiments. The figures do not illustrate every aspect of the described embodiments and do not limit the scope of the present disclosure.

### DETAILED DESCRIPTION

The system 100 is comprised of a database 120, mobile servers 180 and web servers 190, and finally portable electronic devices 225, desktop and laptop computers or thin clients 210, portable electric devices (e.g., tablets, and smart-phones) in which users 220 can access the system. The users access the information over a network 200, such as the internet, in order to access the database 120 information and to transfer and receive information. Firewalls on the user side and database side protect the system and client information.

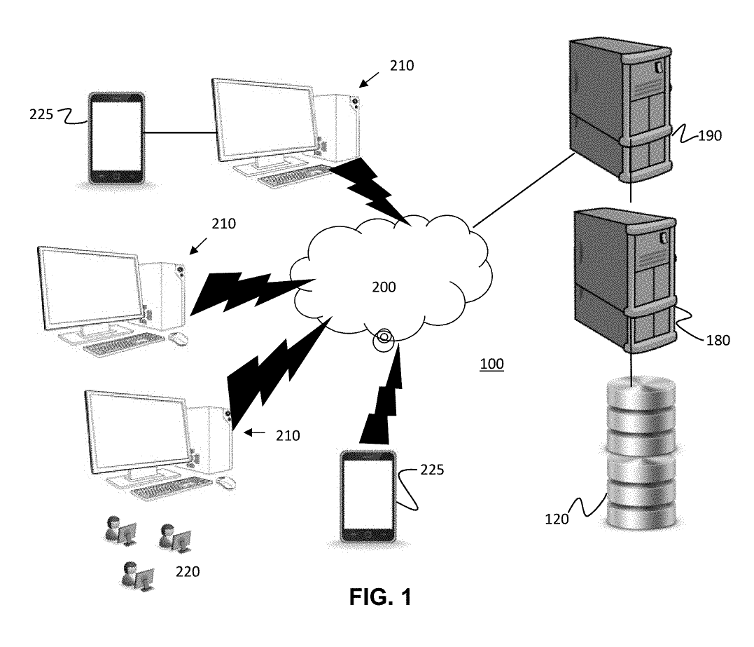

FIG. 1 depicts the basic system architecture for one embodiment. The database 120 stores information for small and medium businesses. The database 120 is a computer database accessible via electronic communication which contains information (e.g., financial data) the small to medium business, data investors, and creditors would prefer to view in certain commercially acceptable formats. The database 120 is periodically updated, e.g., daily or continuously, to include the most accurate, up-to-date information. In one embodiment, the database 120 used is an indexed flat file database. The database 120 is communicatively connected to a database server 180, and may reside on the database server 180 or on a separate computer and/or one or more separate database storage devices. The database server 180 hosts a database management system for managing the steps of writing and reading data to and from the database. The database server 180 controls the flow of information to and from the database 120.

The database server 180 is communicatively connected to a web server 190. The web server 190 hosts information, documents, scripts, and software needed to provide user interfaces and enable performance of methodologies in accordance with an exemplary embodiment of the system and method. By way of example and not limitation, the web server 190 may include web page information, documents and scripts (e.g., Hypertext Markup Language (HTML) and Extensible Markup Language (XML)), applets, and application software, which enables users to submit valuation requests and display valuation data in response to valuation requests from users. The web server 190 connects the database server 180 to the network 200 such as the internet.

In one embodiment, access to the web server 190 is accomplished through use of a personal computer 210 which is electronically connected to the network 200. This connection may be through a wired or wireless local area network.

A plurality of users 220 may access the web server 190 using compatible computing devices with network connectivity. By way of example, such devices may include personal computers, laptop computers, handheld computers, thin clients, personal digital assistants, tablets, mobile phones or any compatibly equipped electronic computing devices. User computing systems may include an operating system and a browser or similar application software configured to properly process and display information, documents, software, applications, applets and scripts provided by the web server. Although three personal computers 210, and two portable electronic devices 225 are shown for illustrative purposes, any number of user computers and portable electronic devices may be used in accordance with the invention.

In one embodiment, access to the web server 190 is accomplished through use of a portable electronic device 225 which electronically connects to the internet. The portable electronic device 225 can electronically connect directly to the internet or be operably connected to a personal computer 210 which connects to the internet.

In one embodiment, a user may access the system through a personal computer 210 through use of a web browser.

The users 220 access the database 120 and its financial business database through an application programming interface (API). An application programming interface is a protocol intended to be used as an interface by software components to communicate with each other.

The system 110 is not limited to any particular network connectivity or communication protocol. Various forms of communication networks may be used by personal computers or portable electronic devices to access the web server. By way of example and not limitation, a proprietary Wide Area Network (WAN) or a public WAN, such as the Internet, may be used. These networks typically employ various protocols such as the Hypertext Transfer Protocol (HTTP), File Transfer Protocol (FTP), Extensible Markup Language (XML), and Transfer Control Protocol/Internet Protocol (TCP/IP) to facilitate communication of information between communicatively coupled computers. The system may also utilize wireless networks, including those utilizing Global System for Mobile (GSM), Code Division Multiple Access (CDMA) or Time Division Multiple Access technology, Wireless Application Protocol (WAP), and Long Term Evolution (LTE). Furthermore, the system may utilize any, all, and any combination of such communications networks, as well as communications networks hereafter developed.

The computing devices described herein (e.g., personal computers, handheld computers, thin clients, servers, portable electronic devices) may be comprised of commercially available computers, hardware and operating systems. The aforementioned computing devices are intended to represent a broad category of computer systems capable of functioning in accordance with the present invention. Of course, the computing devices may include various components, peripherals and software applications provided they are compatible and capable of performing functions in accordance with the present invention. The computing devices also include information, documents, data and files needed to provide functionality and enable performance of methodologies in accordance with an exemplary embodiment of the invention. The computers and electronic systems disclosed consist of processors which perform the electronic steps capable of performing the methods disclosed herein.

A firewall may be located between web server 190 and the database server 180 to protect against corruption, loss, or misuse of data. The firewall limits access by the web server and prevents corruption of data. Thus, the web server may be configured to update and receive data only to the extent necessary. The firewalls may be comprised of any hardware and/or software suitably configured to provide limited or restricted access to the database server 180. The firewalls may be integrated within the database server 180 or another system component, or may reside as a standalone component.

Functions and process steps described herein may be performed using programmed computer devices and related hardware, peripherals, equipment and networks. When programmed, the computing devices are configured to perform functions and carry out steps in accordance with principles of the invention. Such programming may comprise operating systems, software applications, software modules, scripts, files, data, digital signal processors (DSP), application-specific integrated circuit (ASIC), discrete gate logic, or other hardware, firmware, or any conventional programmable software, collectively referred to herein as a module.

The application runs on separate database and application servers. Access to the database is allowed only by the application itself or administratively through accounts held by the provider. All connections of any kind to any aspect of the system are encrypted and secure. Users accessing the application must be named with no guest or anonymous usage permitted. Administrative account-holders have access only to business logic and user account information and not to user-identified data. Aggregate data are anonymized and accessed through a separate code base to ensure that comparative data analytics and query tools cannot be used as a means of attacking the system.

The system 100 and method disclosed permit non-expert users 244 to authorize the system 100 to continuously collect and update data 240 from any number of cloud-based systems and services. The application manages all activities and analysis associated with these data across multiple levels of access rights in the authorization and sharing application 400 including user-only, firm-only, private groups, user-accessible collective views, and derivations from collective analysis such as scores and recommendations.

The system 100 and method permits access by the application on behalf of authorized users 244 with designated privileges. For financial and other data also in similar form, such privileges may be specified at the cell or object level rather than a row or table. Firms select user 244 access rights upon creating private groups that trigger rights at the most granular level. In this manner, the system 100 will expose data associated with cell-specific rights granted by the firm to the group. Added layers of protection prevent participants of one group from gaining non-permitted access to other groups.

The system 100 and method disclosed is a web-based service that allows non-expert users in the firms to create a profile, upload and/or sync essential data including financial reports 240 and selectively share that data with one or more creditors. A non-expert user is a person who is not a specifically trained credit expert or programmer. Private data such as financial reports are organized at the source to be viewed as summary information typically in a spreadsheet-like format. Either accounting software or each firm may further secure such data 240 to prevent recipients from intentionally or inadvertently corrupting them. Such data 240 are first parsed by the system 100 in order to initiate the method to normalize the firm's data against a common taxonomy and perform additional analysis as required in major creditor evaluations. For example, a balance sheet report will be parsed by the system 100 and stored as a body of individual cells each of which carry attributes from the source report as well as attributes provided by the user 244 upon creating a profile. Source report attributes typically include a line item name from the firm's chosen chart of accounts, a date, the type of report such as balance sheet or income statement and the state of the report such as history or forecast. User-supplied attributes 248 may include but are not limited to firm's stage of maturity, region, target market, number of employees, and organizational model.

Parsed data 242 are first visualized for the user 244 in the original format for confirmation that the source data are correctly read by the system 100 and then are visualized as reconstituted according to recommended tags 605. The parsed data 242 and recommended tags 605 are then presented to the user 244 who may modify the system's initial normalization attempt by adding, deleting or editing tags to accurately represent and classify their firm's financial performance or forecasts. When mapping is complete, the system 100 further processes the data to produce key metrics and visualizations that creditors need in order to properly evaluate the firm. In this way users 244 are able to see the way their firm will be viewed by their creditors when they invite them into the system 100.

With the data for a firm loaded into the disclosed system 100, the firm is able to share selected portions as desired with multiple creditors without additional effort. The user 244 may select from system-generated access rights or customize presentations. In either case, the system 100 sorts through the body of cell-level data according to attributes gathered from implicit and explicit actions to create the desired level of access. The disclosed system 100 also applies the firm's previously approved parsing and mapping to subsequently uploaded data which makes it possible to keep such information up-to-date for ongoing reporting obligations as well as modify previously authorized access rights with very little effort.

By enabling many-to-many exchanges of data between firms and creditors, the disclosed system 100 is able to aggregate data and learn from all interactions for the purposes of verifying data fidelity 800 as well as deriving new bases for analysis including comparative baselines 490. In the example of a balance sheet, the system continues to add non-identifying attributes 246 and identifying attributes 248 to each stored cell of financial information that may be used to generate recommendations 495, enrich the context for understanding and predicting performance of each firm. The system 100 will associate actions such as the number of times a data object has been made available for identified views by an invited user 244, the number of times such an invited user 244 has viewed that data object, the frequency of use of the system by such an invited user 244, the number of times that data object has been over-ridden by updates, and the number of times it has been queried in the context of non-identified aggregates.

By deploying in cloud-based architectures, the system and method are able to continuously assign new attributes to each data object 480, permit non-expert and expert users 244 to conduct analysis to meet credit practices as they evolve, and support rich comparative views without jeopardizing the privacy and security concerns of both firms and their creditors. This level of visibility combined with fine-grained data security allows regulated creditors such as Federal Deposit Insurance Corporation (FDIC)-insured lenders to balance client management with compliance obligations.

By associating data objects with continuous additions of identifying and non-identifying attributes, each embodiment of such data may be accompanied by automated credit recommendations 495. For example, a user 244 with the right to view metrics derived from a balance sheet but not the balance sheet report may receive recommendations such as a note that the firm to which the metric pertains is in the top 10 percent of like firms that are good credit risks 490 or that the user may request additional access rights. In the case of a user 244 with the right to view all financial metrics and high-level information in report format, the user 244 may receive a recommendation to request additional information to verify the nature of short-term assets and liabilities of the firm. In the case of a user 244 with the right to view detailed income statement information, the user may receive a recommendation to request a forecast for the next 12 months or additional years of history in order to meet the user's credit evaluation processes or regulations. In the case of the firm to which any such data pertain, the user 244 may receive a recommendation to seek additional or alternative forms of financing as a result of compliance with credit evaluations or as a result of comparisons to financing vehicles in use by like firms.

When the number of firms substantially similar to any specific user grows to at least 20 firms other than the user 244, the system 100 and method may generate specific recommendations to grant or deny credit to the user 244 accompanied by further detailed recommendations including but not limited to steps the firm may take to improve its ability to gain credit and steps the creditor may take to help the firm gain credit or to mitigate risk associated with granting credit to the firm.

In the case of patterns of behavior for verification purposes 840, a participating firm can be compared against the larger population of users to establish additional heuristics to determine overall trustworthiness of supplied credit information. For example, questions may be raised as to the relative validity of data from a firm that has updated their data significantly less often 720, has not invited as many creditors, or has fewer, less active discussions than their peers. Creditors can request 760 that the firm provide more data or explain these anomalies in order to complete their evaluation. Further, the present system 100 continuously aggregates financial data in order to provide both firms and creditors with access to near real-time baseline metrics against which they may benchmark financial performance. Firms can use these data to see how they are doing relative to their peers as determined by non-identifying attributes such as their industry and/or region. Creditors can use baselines as a further input into their evaluation of a particular firm.

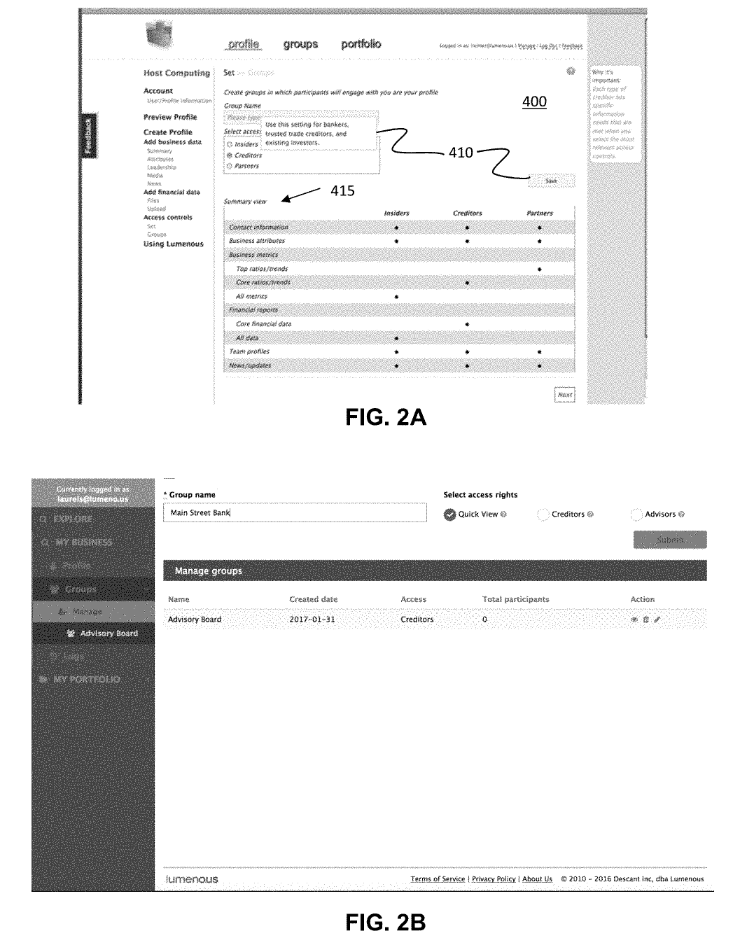

FIG. 2A depicts an embodiment of the profile view from the system authorization and sharing application 400. In one embodiment, this view allows users 244 to create groups in which participants will engage with the user 244 and view the user's business profile 410. The application allows users 244 to edit the types of information available to advisors, creditors and business partners. In one embodiment, the summary view of profile information 415 can include contact information, business attributes, (such as top ratios, core ratios/trends, metrics, etc.), financial reports including core financial data, team profiles and news/updates. FIG. 2B is another embodiment of the profile view of the system. A user 244 may choose from pre-determined views including Quick View, Creditors or Advisors. This view allows users 244 to manage created groups (e.g., an Advisory Board). This view also allows a user 244 to manage and update a particular group by logged name (e.g., Main Street Bank). This view provides the total number of participants, the Access role (e.g., Creditors) and allows communication with the group.

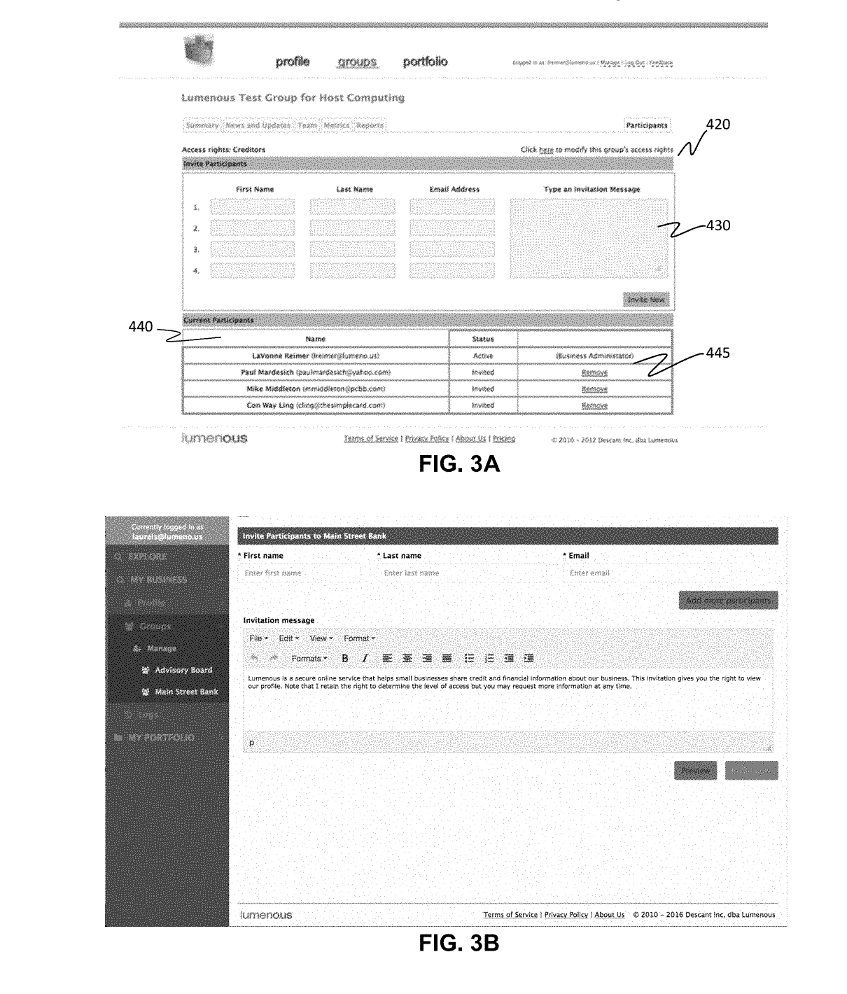

FIG. 3A depicts an embodiment of the groups view from the system application. In one embodiment, this view allows users 244 to modify access rights for the group 420. The application allows users 244 to invite participants to access information in the system 100. This view also provides for a customized invitation message 430 and lists current participants 440 and their status of participation. The page also allows users to remove participants 445 as desired. FIG. 3B depicts another exemplary embodiment of the groups view from the system application. This view provides additional editing capabilities for sending messages and the capability to preview messages prior to sending.

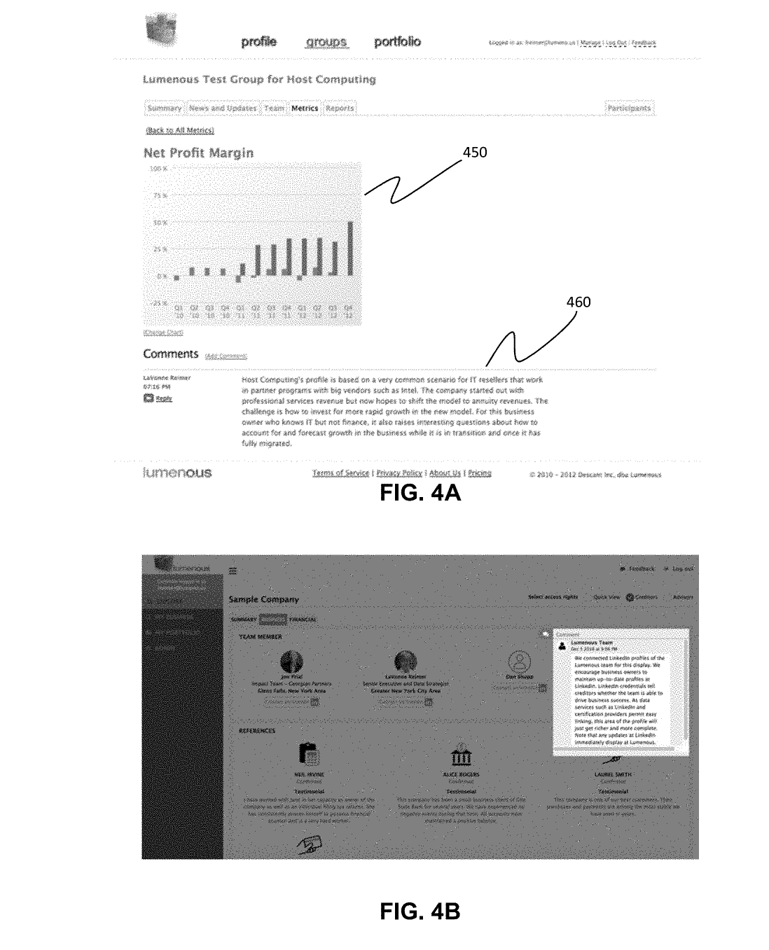

FIG. 4A depicts an embodiment of the metrics page for the system application. In one embodiment, upon selection by the authorized user 244 from all available metrics in the permitted view, the Net Profit Margin 450 may be displayed for the user's business. The system 100 allows for comments 460 to be entered to explain the metrics displayed as well as request additional information. FIG. 4B illustrated another exemplary embodiment of the Summary page. This embodiment provides links to contact team members in addition to Confirmed references and testimonials provided by third parties.

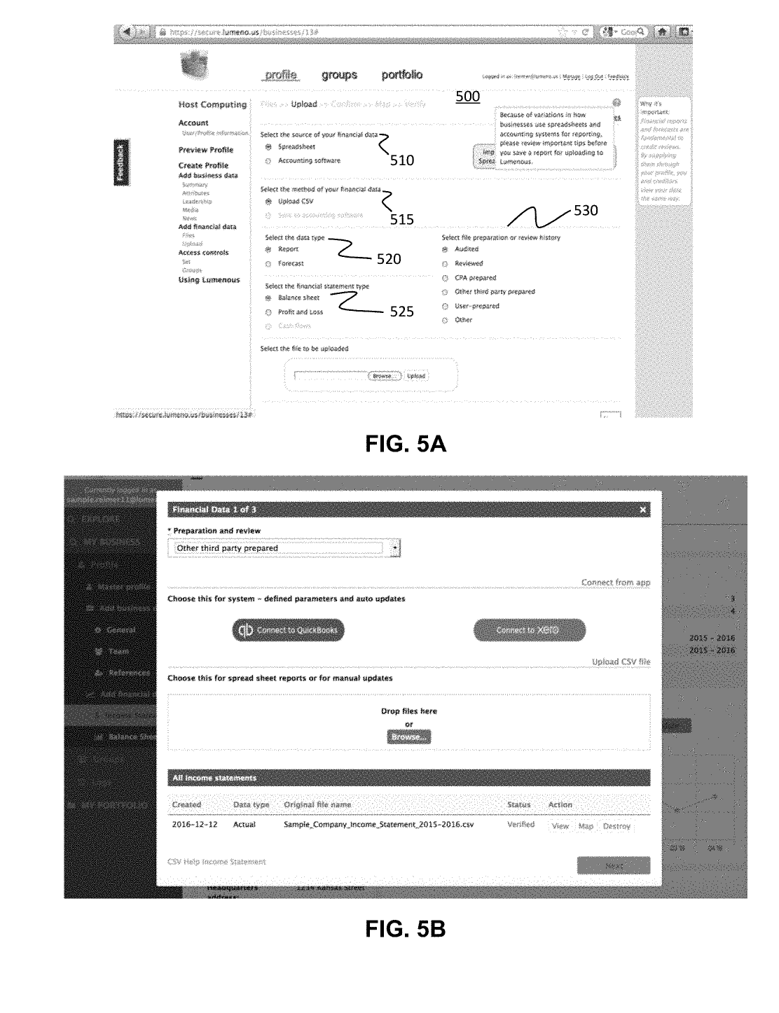

FIG. 5A illustrates the system interface 500 that allows a user to upload his or her firm's financial data. The presently disclosed system 100 accepts data periodically uploaded by users in the form of Comma Separated Values (CSV), a common export file format used by spreadsheet and accounting software 510, or by user-authorized syncing in the case of accounting software providers that support cloud data services. The application collects and/or tracks additional non-identifying attributes regarding the financial data including state or timeframe 520, type of report 525, and preparation method or review history 530 whether by the user or another preparer. FIG. 5B is another embodiment of the system interface. This interface allows for linking information from other commercially available accounting software, e.g., QuickBooks or Xero. Files may also be dragged and dropped into this interface for manual entry or a user may browse the system files to locate the file to upload. The system interface also allows lists all income statements and can provide the date created, data type, Original File Name, Status (e.g., verified). The system interface allows users to View, Map or destroy these files.

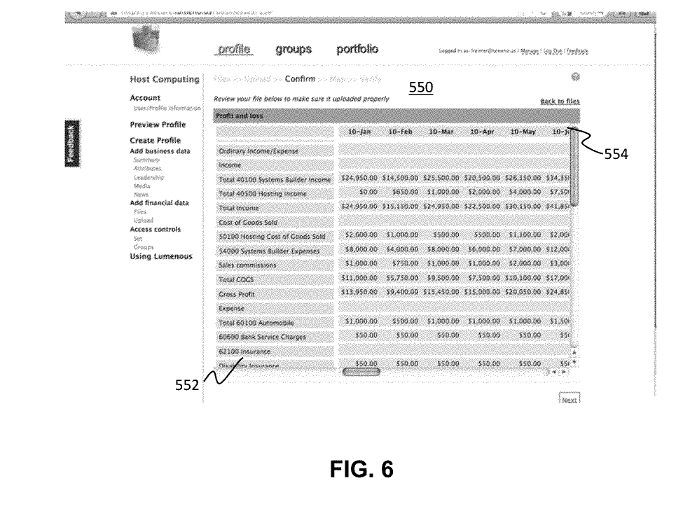

FIG. 6 illustrates the initial review display 550 that allows the user 244 to ensure his or her data have been properly uploaded. The original data are presented to the user 244 for review including original row label 552 and dates 554. The application maintains this record as a component of data verification and for the purpose of capturing collective mapping history that may organically drive to new standard taxonomies according to business attributes.

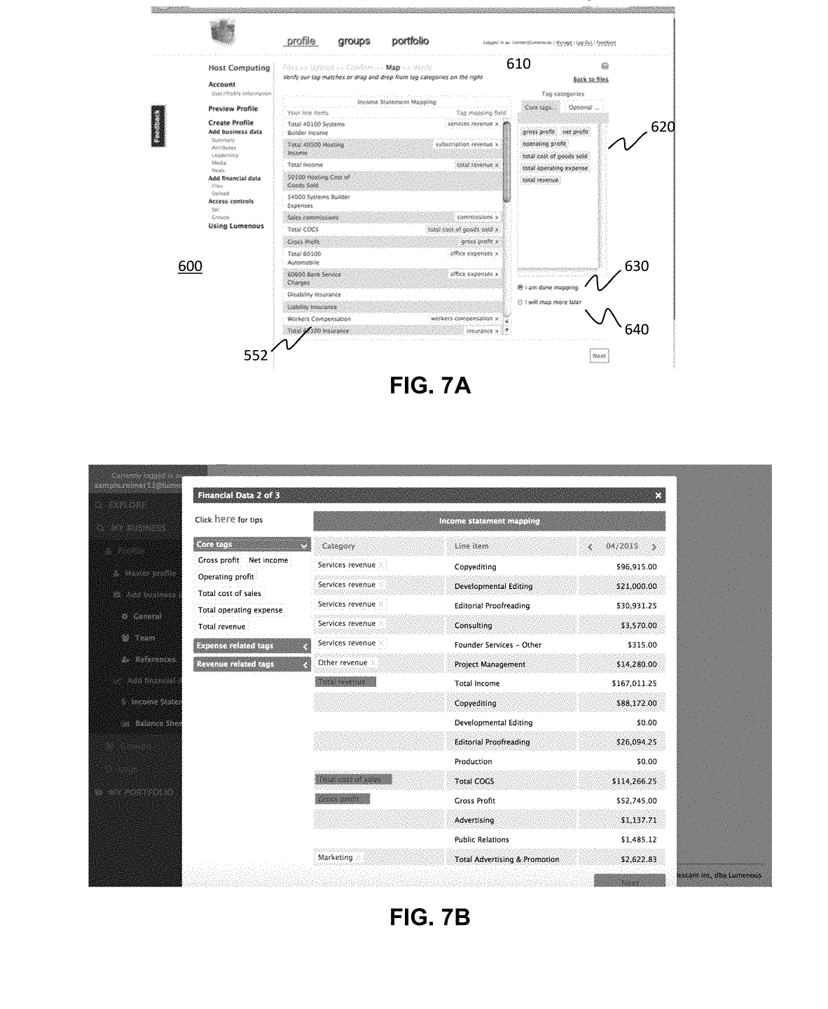

FIG. 7A illustrates one embodiment the mapping interface 600 in which a user 244 is shown the parsed, uploaded data and is able to adjust initial mapping through the use of “tags” and may be modified by mapping, adding, deleting or editing the linkages to accurately represent the firm's financials. In order to make modifications, the user 244 may simply drag and drop tags beside the core tags 620 that can be the original row labels. When such modifications are complete, the user 244 submits the data 630 to the system 100 and tag mappings are marked as “accepted” in the database. The next time the user 244 uploads a new version of the data, the tags mapped to each row are retrieved from the database and reused. In this way, unless the row labels have changed, the tagging will be exactly the same as the user's accepted mapping from the previous session. Tag mappings supplied and approved by users across the entire system 100 are also stored in a separate database that helps inform future parsing and mapping exercises 640. In this way the system 100 learns from users' efforts, improving the mapping from session to session across all the firms using the presently disclosed system 100. New tags can also be suggested by users 244 that, once they are approved by system administrators, will be added to the collection of tags available to all users 244 of the system 100. The net result is a universal system for mapping idiosyncratic financial data formats to a single standardized taxonomy and format that can adapt and learn from the actions of the users who supplied the original, non-normalized data. The core tags can include Gross Profit, Net Income, Operating Profit, Total Cost of Sales, Total Operating Expense, and Total Revenue. FIG. 7B is another embodiment of the mapping interface 600. This interface allows for mapping expense related tags and revenue related tags. This interface also provides tips for conducting the mapping.

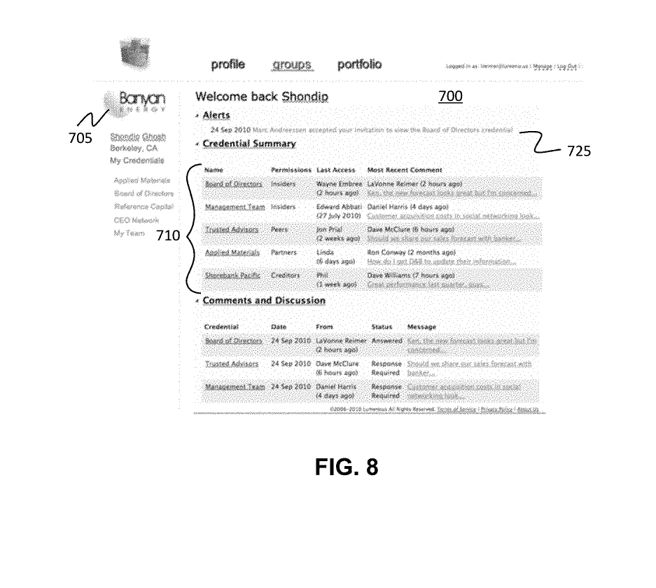

FIG. 8 illustrates the assessment interface 700 for viewing activities of the kind that are observed and analyzed for trust assessment. This feature is a component of the presently disclosed system 100, a web-based service that allows firms to create a profile, upload or sync data such as financial reports, and selectively share that data with one or more creditors. Once the financial data for a firm is loaded into the present system as normalized, the user is able to share it selectively in its identified form (the name of the firm 705) with multiple creditors and stakeholders without additional effort. Each action taken by a user 244 will be logged 710 for analysis. For example, the system 100 tracks the frequency with which the firm uploads refreshed financial data, variances in data relative to previous uploads for similar periods 720, the number of company stakeholders invited 725, the number of creditors invited 730, and the level of permissions and activity of all invited users 735. Interactions with invited creditors 750 and stakeholders will also be analyzed. The system has a mechanism for participants to comment upon and discuss aspects of the firm's financial data and the degree and frequency of these interactions will be logged and analyzed 460.

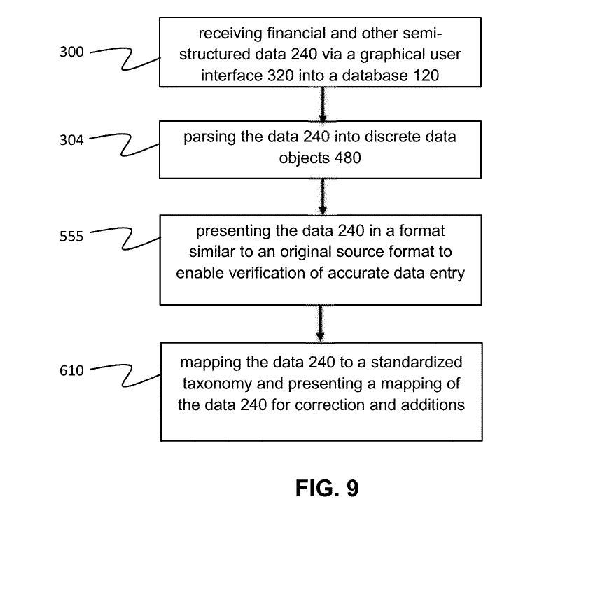

FIG. 9 illustrates an embodiment of a computer implemented method for self-aggregation of business information, suitable for implementation on a processor, comprising receiving, at 300, user-supplied financial and other semi-structured data 240 via a graphical user interface 320, into a database 200; parsing, at 304, the data 240 into discrete data objects 480; presenting, at 555, the data 240 in a format similar to an original source format to enable verification of accurate data; mapping, at 610, the data to a standardized taxonomy and presenting a mapping of the data for correction and additions.

Row labels are examined and simple string matching, synonym search and other linguistic parsing techniques are applied to find the best “guess” that maps a user's row label to a system-seeded taxonomy for financial data. The selected “tag” is stored in the system database alongside the user's original data but is initially marked as “unreviewed.” The formatted data is shared 306 with a plurality of authorized users over a network 200.

In one exemplary embodiment the processor is embodied in a cloud client. In one exemplary embodiment the claimed method is implemented in a cloud based environment.

The method can be implemented on a portable electronic device, such as a tablet, notebook, desktop, smartphone, or similar device.

The method can further comprise applying interactive machine-learning techniques whereby at least one user assists translating data objects stored as semi-structured, non-standard financial data into a plurality of machine readable data; and reconstituting the data objects for near real-time user queries according to a standardize-able taxonomy. Users as described herein are a plurality of non-expert users. Application of interactive machine learning involves such non-expert users engaging with elements specific to driving greater accuracy in the functions required of a many-to-many credit system including: translation and normalization of specific inputs from non-standardized reports of semi-structured format; sharing rights/access controls defined by the system (in the case of templates) and users at the level of attributes; verifying the fidelity of data (which must be done at the data object level in order to permit fine-grained assessments). Reconstituting is a single action that encompasses aspects of each of the three functions described above. The only way to make core credit data shareable in a many-to-many environment is to parse reports to discrete data objects. As part of that, the only way to make interactive machine learning have integrity across the inputs of a plurality of non-expert users is to track inputs at the discrete data object level as well as assign attributes and associate contextual and social information/activities at the discrete object level.

The method can further comprise parsing permits fine-grained application of interactive machine learning to the data.

The computer implemented method can further comprise applying results from mapping activities performed by at least one user to subsequent mapping; displaying results from continuously improved accuracy and relevance to benefit subsequent users; and applying results from continuously improved accuracy and relevance to computer executed instruction for conducting credit analysis.

The computer implemented further comprising mapping the user-aggregated financial and similarly structured non-financial data to schema-defined taxonomies in order to make a plurality of such data machine readable.

In one embodiment of the computer implemented method the graphical user interface is specific to the series of user contributions, both explicit and implicit, that are required to accurately translate a plurality of semi-structured, non-standard data as input by a plurality of firms.

In one embodiment of the computer implemented the graphical user interface enables a user to create and publish a taxonomy of tags that will be mapped against such semi-structured data and presented to the user for correction and approvals that further train such translation and normalization process.

In one embodiment of the computer implemented method the graphical user interface enables a non-expert user to create and publish metrics and other displays of such semi-structured data.

In one embodiment of the computer implemented method the graphical user interface enables a non-expert user to create and publish permissions for sharing such semi-structured data.

In one embodiment of the computer implemented method further comprises formatting the data objects into a non-expert user selected semi-structured format similar to financial reports with no programming required, wherein the formatting is performed by a processor.

In one embodiment of the computer implemented method the parsing is applied to a balance sheet.

In one embodiment of the computer implemented method the parsing is applied to an income statement.

In one embodiment of the computer implemented method the parsing is applied to a cash flow statement.

In one embodiment of the computer implemented method the parsing is applied to a form containing business information substantially similar to financial reports in that numbers appear in cells and attributes for each cell are presented in text on the form.

In one embodiment, the computer implemented method further comprises publishing by a non-expert user via a graphical user interface a schema including taxonomy, metrics, display options, and permissions to be used in parsing, translating, and normalizing user-input semi-structured data similar to the format of, but not specifically, financial data.

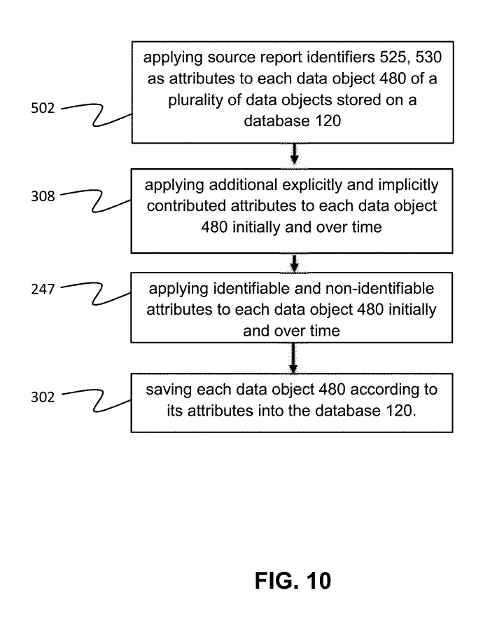

FIG. 10 illustrates an embodiment of a computer implemented method for applying attributes to business information, suitable for implementation on processor, comprising: applying, at 502, source report identifiers 525, 530, as attributes to each data object stored on a database; applying, at 308, additional explicitly and implicitly contributed attributes to each data object initially and over time; applying, at 247 identifiable and non-identifiable attributes to each data object initially and over time; and saving, at 302 each data object according to its attributes into the database.

In one embodiment, the computer implemented method further comprises generating access rights according to prepared templates consisting of selected attributes based on creditor-identified requirements for credit analysis.

In one embodiment, the computer implemented method further comprises publishing via a graphical user interface, a list of attributes and data objects whereby a non-expert user may configure access rights for any number of creditors and other parties the user may invite to view credit information.

In one embodiment, the computer implemented method further comprises publishing via a graphical user interface, a record of all previously authorized access rights whereby a non-expert user may modify level of access.

In one embodiment, the computer implemented method further comprises generating a credit recommendation based on analysis of user-specific activity, wherein the generating is performed by a processor.

In one embodiment, the computer implemented method further comprises generating a credit recommendation based on analysis of comparative activity, wherein the generating is performed by a processor.

In one embodiment, the computer implemented method further comprises generating a credit recommendation based on analysis of user-specific data patterns, wherein the generating is performed by a processor.

In one embodiment, the computer implemented method further comprises generating a credit recommendation based on analysis of comparative data patterns, wherein the generating is performed by a processor.

In one embodiment, the computer implemented method further comprises generating a credit recommendation based on financial data aggregated according to non-identifying attributes, wherein the generating is performed by a processor.

In one embodiment, the computer implemented method further comprises generating a plurality of system-selected metrics based on comparative activities and aggregate data, wherein the formatting is performed by a processor.

In one embodiment of the computer implemented method the processor is embodied in a cloud client. In one embodiment of the computer implemented method, the method is implemented in a cloud based environment.

In one embodiment, the computer implemented method is implemented in a portable electronic device, such as a tablet, notebook, desktop, smartphone, or similar device.

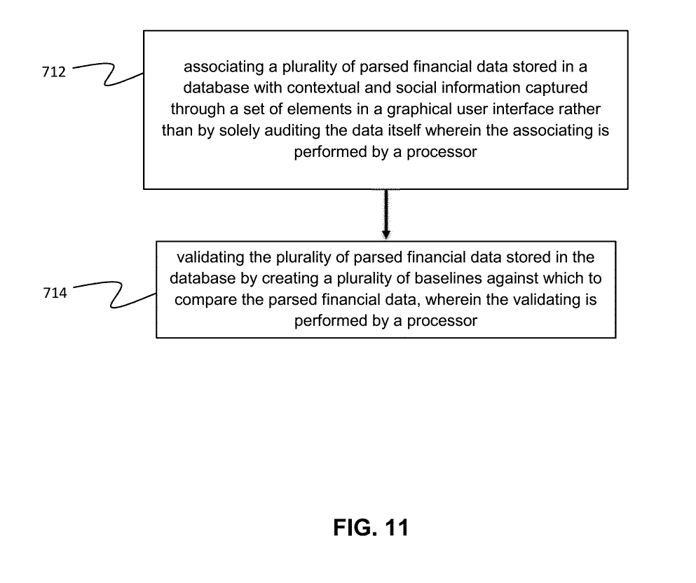

FIG. 11 illustrates a computer implemented method for validation of business information, suitable for implementation on a processor, comprising: associating, at 712, a plurality of parsed financial data stored in a database with contextual and social information captured through a set of elements in a graphical user interface rather than by solely auditing the data itself wherein the associating is performed by a processor; and validating, at 714, the plurality of parsed financial data stored in the database by creating a plurality of baselines against which to compare the parsed financial data, wherein the validating is performed by a processor.

One embodiment of the computer implemented method further comprises adapting interactive machine-learning techniques to translation and normalization of data objects, both explicit and implicit, from a plurality of users in which an integrity of underlying models improves with increased number of applications of the models.

One embodiment of the computer implemented method further comprises prompting user contributions via the graphical user interface, wherein the graphical user interface is designed to promote incentives to engage in commercial credit analysis in which an integrity of data fidelity verification improves with increased number of applications of the analysis.

In one embodiment of the computer implemented method the graphical user interface is specific to the series of user contributions, both explicit and implicit, that are required to aggregate usage and data patterns of a plurality of users across the network that collectively accrue to inform data fidelity determinations.

In one embodiment of the computer implemented method the graphical user interface is specific to a series of user contributions, both explicit and implicit, that are required to infer degrees of fidelity of the data of a specific firm.

In one embodiment of the computer implemented method, the graphical user interface is specific to a series of user contributions, both explicit and implicit, that are required to infer degrees of fidelity in the data of a specific firm as compared to collective user contributions applied against a plurality of user-inputted data.

In one embodiment the computer implemented further comprises verifying the data objects by tracking a plurality of sharing activities including invitations, responses, comments and ratings and correlating such activities to patterns within any specific dataset, wherein the verifying and correlating is performed by a processor.

In one embodiment, the computer implemented method further comprises generating a fidelity assessment based on business or non-financial data aggregated according to non-identifying attributes, wherein the generating is performed by a processor.

In one embodiment the computer implemented method further comprises: verifying user-input data similar to the format of but not specifically financial data by tracking a plurality of sharing activities including invitations, responses, comments and ratings and correlating such activities to patterns within such dataset, wherein the verifying and correlating is performed by a processor; and verifying a plurality of user-input data similar to the format of but not specifically financial data by creating a plurality of baselines against which to compare the parsed financial data, wherein the validating is performed by a processor.

In one embodiment of the computer implemented method the processor is embodied in a cloud client. In one embodiment the computer implemented method is implemented in a cloud based environment.

In one embodiment, the computer implemented method is implemented in a portable electronic device, such as a tablet, notebook, desktop, smartphone, or similar device.

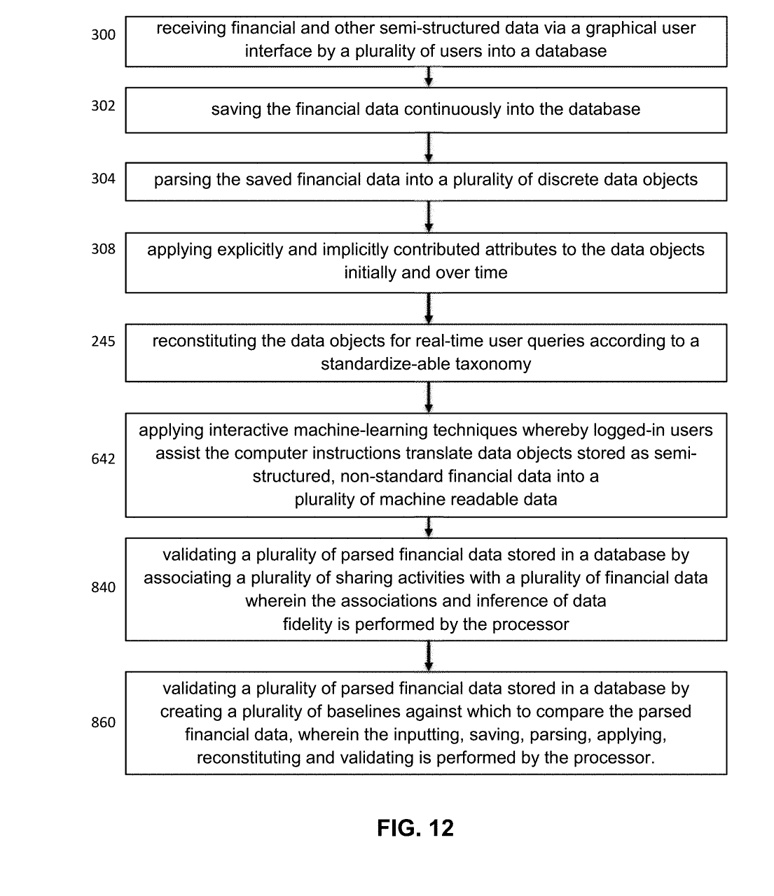

FIG. 12 illustrates a computer implemented method for self-aggregation, tagging, and validating of business information, suitable for implementation on a processor, comprising: receiving, at 300, financial and other semi-structured data via a graphical user interface by a plurality of users into a database; saving, at 302, the financial data continuously into the database; parsing, at 304, the saved financial data into a plurality of discrete data objects; applying, at 308, explicitly and implicitly contributed attributes to the data objects initially and over time; reconstituting, at 245, the data objects for real-time user queries according to a standardize-able taxonomy; applying, at 642, interactive machine-learning techniques whereby logged-in users assist the computer instructions translate data objects stored as semi-structured, non-standard financial data into a plurality of machine readable data; validating, at 840, a plurality of parsed financial data stored in a database by associating a plurality of sharing activities with a plurality of financial data wherein the associations and inference of data fidelity is performed by the processor; and validating, at 860, a plurality of parsed financial data stored in a database by creating a plurality of baselines against which to compare the parsed financial data, wherein the inputting, saving, parsing, applying, reconstituting and validating is performed by the processor.

Row labels are examined and simple string matching, synonym search and other semantic parsing techniques 304 to find the best guess that maps a user's row label to a system-seeded taxonomy for financial data. The claimed method provides for continuously improved mapping, models, and fidelity assessments according to the contributions of a plurality of users.

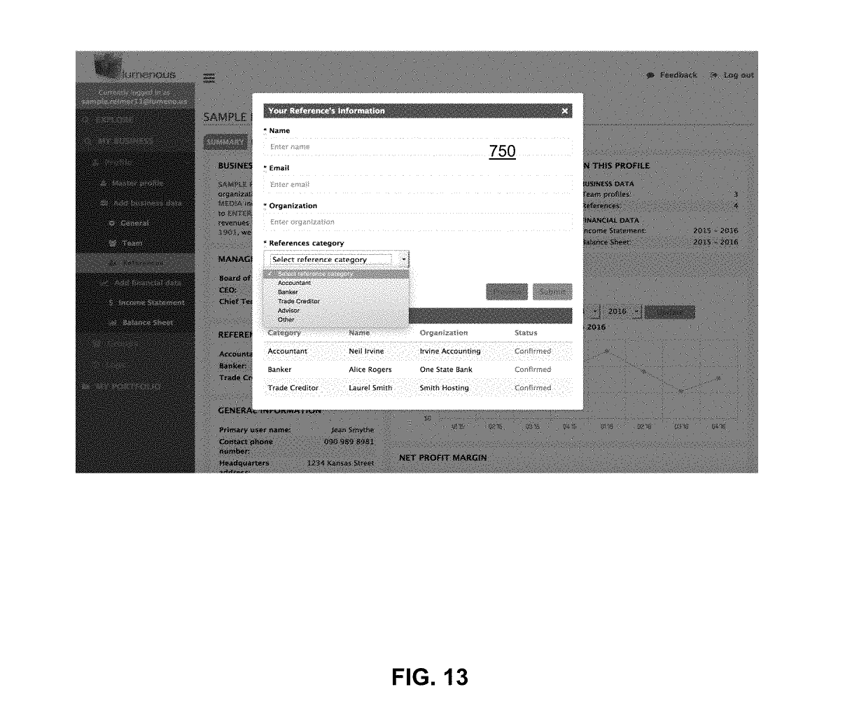

FIG. 13 illustrates an embodiment of the claimed method in which a user requests a permissioned user to provide a reference 750 and selects a category of reference provider (e.g., accountant, banker, trade creditor, advisor or other), saved in the database as a non-identifying attribute 248 for associations used in assessing the level of fidelity of data input by the requesting user.

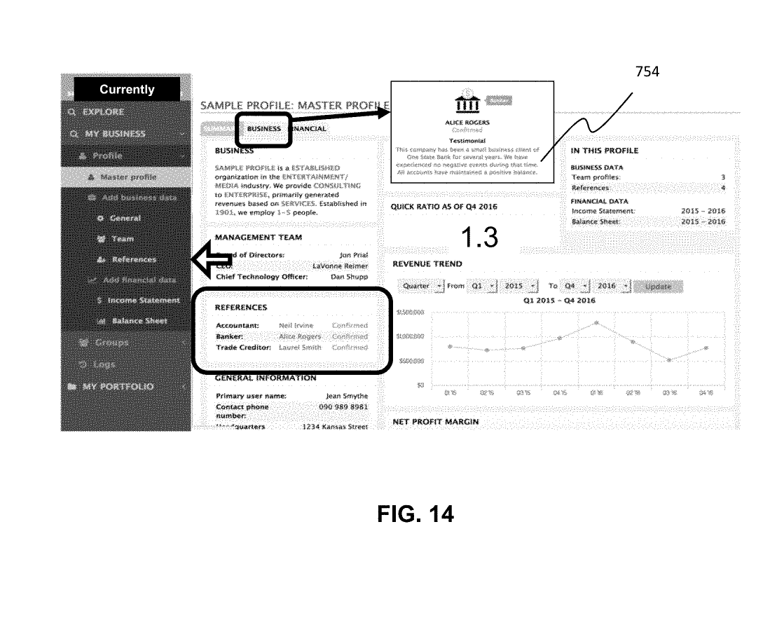

FIG. 14 illustrates an embodiment of the claimed method in which the user has requested another party to provide a testimonial 754 as context for other data being shared by the user. In this example, the reference is provided by the banker for the firm and the banker has entered a testimonial for display, the combined effect of which is to allow viewers of the firm's profile to assess the creditworthiness of the firm and the level of fidelity of data input by the user.

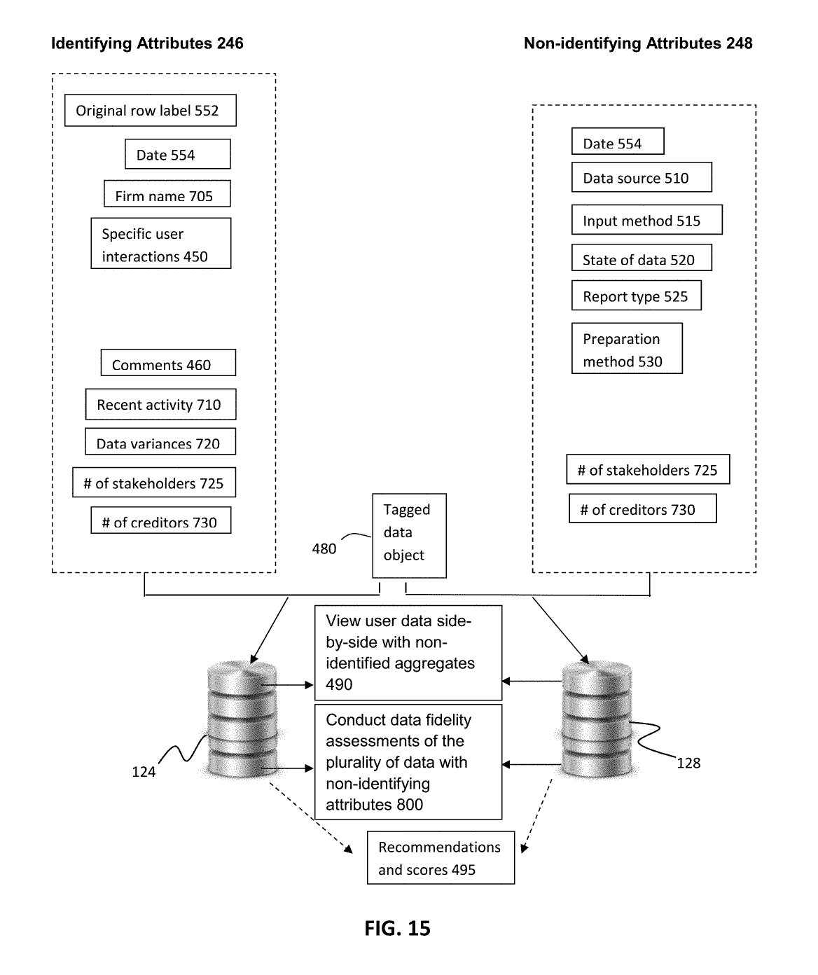

FIG. 15 illustrates an embodiment of the claimed method in which a plurality of attributes are applied to each data object 480 as parsed and tagged are stored in a database for data associated with identifying attributes 246 and a database for data associated with non-identifying attributes 248. In this manner, the application is able to infer degrees of data fidelity 800 and optimize the value of comparative data 490 for the purpose of providing recommendations 495 and further verifying data fidelity without unnecessary and unwanted exposure of the firm's identity. The identifying attributes 124 can include: original row label 552, date 554 as used in identifiable views of the profile, firm name 705, specific user interactions 450, comments 460, recent activity 710, data variances 720, number of stakeholders 725, and number of creditors 730. The non-identifying attributes, 128, can include attributes describing the nature of the business in general terms such as stage of growth and region of the country as well as attributes that are disassociated with the firm name including date 554, data source 510, input method 515, state of data 520, report type 525, preparation method or review history 530, number of stakeholders 725, and number of creditors 730. User data is viewed side-by-side with the aggregate data of comparable firms using non-identifying attributes 128. The system conducts data fidelity assessments of the plurality of data with the non-identifying attributes, 128. The system generates recommendations and scores.

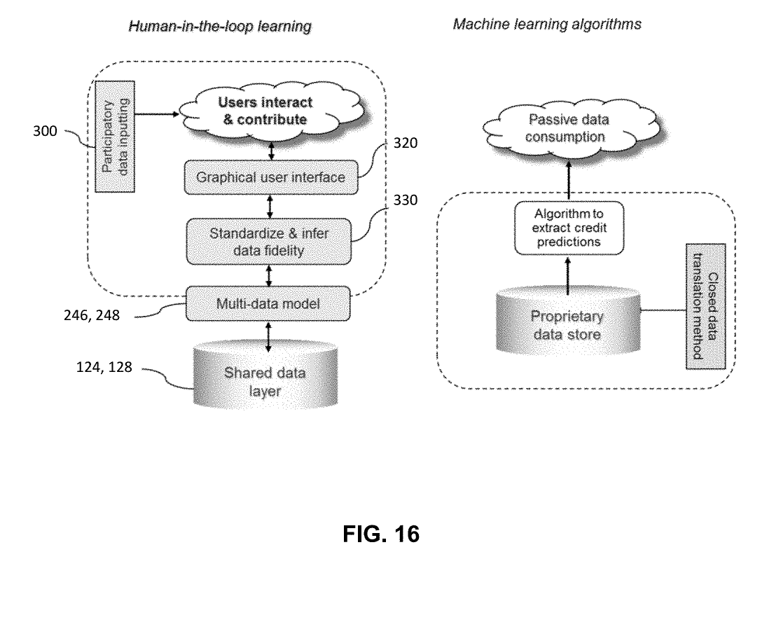

FIG. 16 illustrates an embodiment of the claimed method for applying interactive machine learning techniques, as compared to non-interactive machine learning, in which selected elements are exposed to non-expert users through a graphical user interface 320 wherein such interactions have the effect of improving the integrity of data translation and normalization and inferences of data fidelity 330.

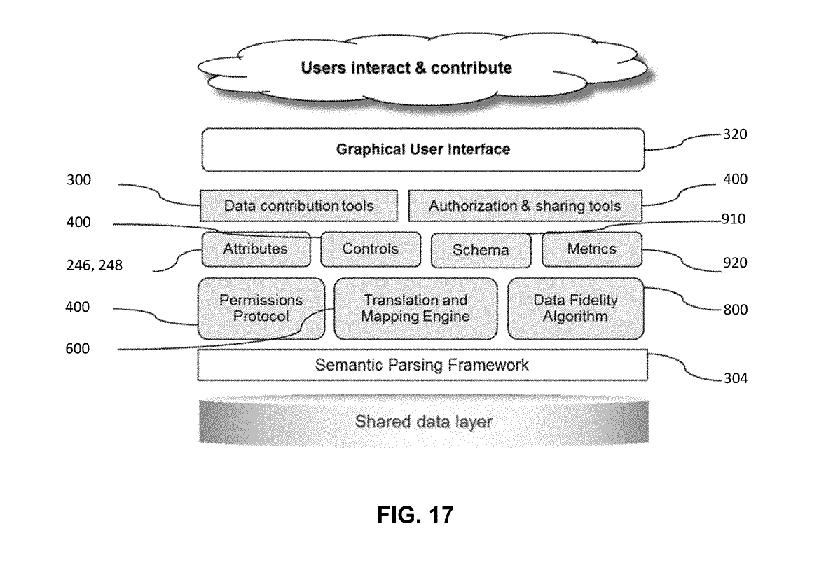

FIG. 17 illustrates an embodiment of the claimed method comprising a graphical user interface 320 and its connection to the system for allowing non-expert users to input data 300 for parsing 304, assist in the translation and normalization of such data using the mapping interface 600, authorize and share such data 306 according to attributes, authorization and sharing application 400 (effectively, attribute-based access controls) and a set of permissions 930, 960, 990, that are displayed for creditors to review and interact in language 900 and visualizations that increase the accuracy and timeliness of credit assessments.

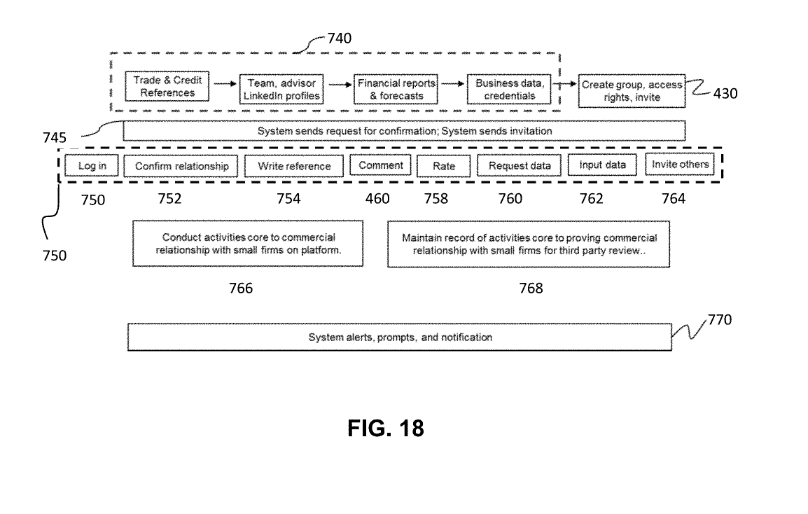

FIG. 18 illustrates an embodiment of the claimed method comprising a graphical user interface allowing non-expert users to input data to a profile in a series of steps for which such user may request related contributions 740 by other non-expert users 750 that will be associated with data for the purpose of credit assessments, recommendations and fidelity assessments. Such users contributing to a profile upon request of the firm are presented with a graphical user interface through which such user may engage in the following activities each of which will be visible to the firm and at the firm's decision, visible to other viewers of the profile: confirm the existence of a commercial relationship 752, write a testimonial 754, comment on a data object in the firm's profile 460, provide a rating 758 of a data object in the firm's profile, request additional data 760, input new data 762 according to permissions granted by the firm, request that the firm invite additional users 764, conduct evaluation activities related to the firm 766, and maintain a record of all such contributions 768. The system 100 provides notifications and alerts 770 to various parties depending on the action.

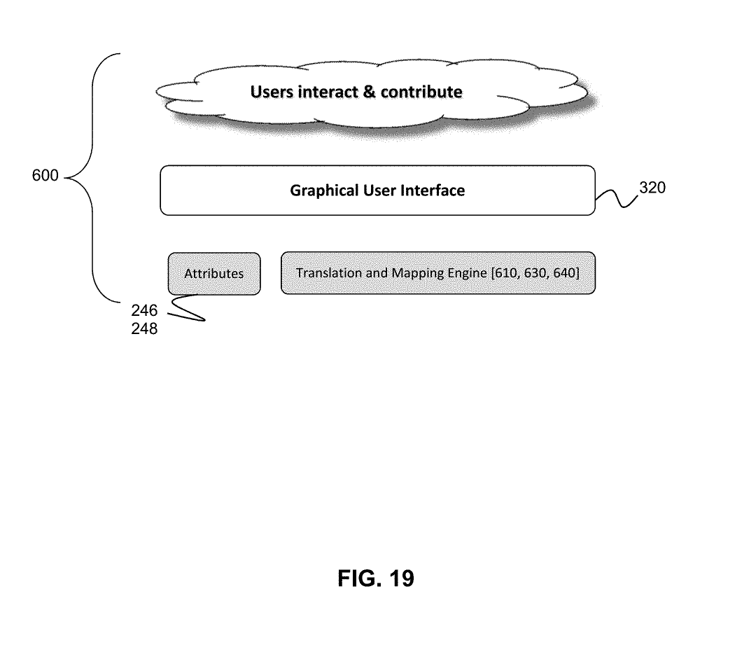

FIG. 19 illustrates an embodiment of the claimed method for translation and normalization using the mapping interface 600 comprising a graphical user interface 320 incorporating the elements for viewing, correcting, and approving the presentation of initial mapping, connected with components 610, 630, and 640 of the translation and normalization engine in a manner that allows the engine to improve in accuracy over time.

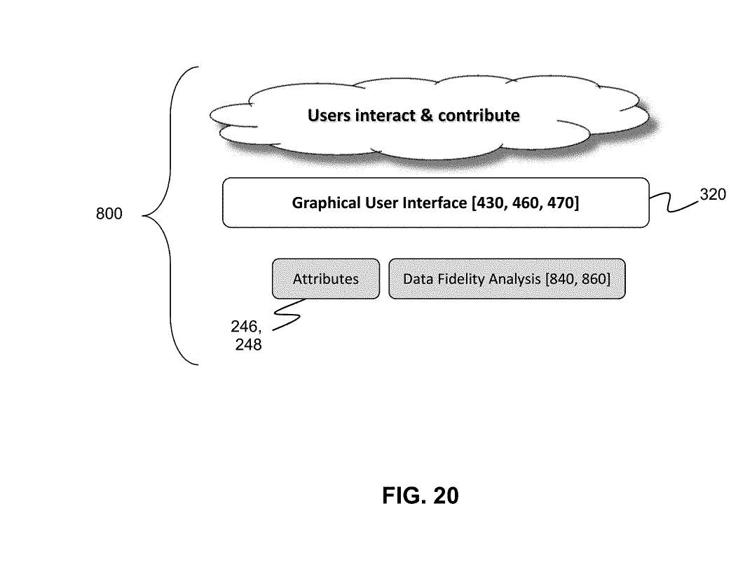

FIG. 20 illustrates an embodiment of the claimed method for verifying data fidelity 800 comprising a graphical user interface 320, incorporating the elements for receiving contextual 470 and social 450, 460 information associated with data objects according to both identifying and non-identifying attributes. Such elements interacting with the data fidelity analysis engine 800 leading to an assessment of the fidelity of the data.

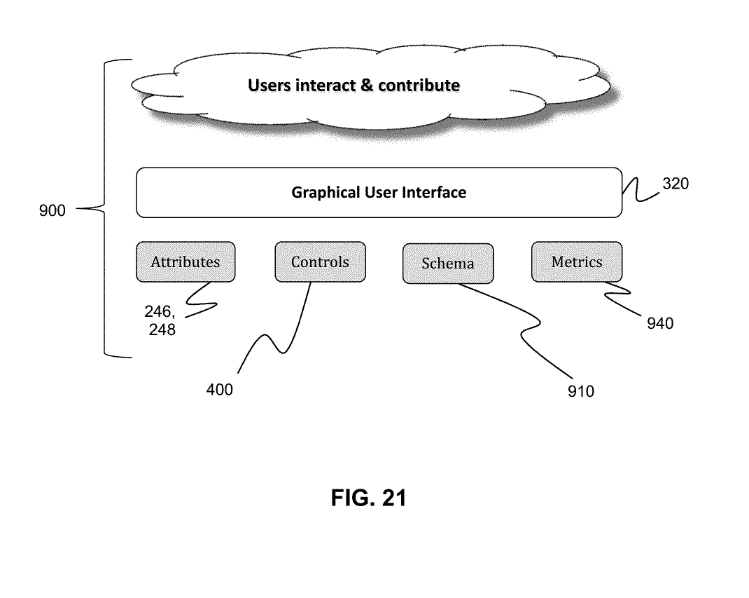

FIG. 21 illustrates an embodiment of the claimed method related to the schema process 900 comprising a graphical user interface 320 through which a non-expert user is able to apply the process for inputting and managing data in substantially similar form to financial data but not specifically financial data including the definition of its schema taxonomy 910, metrics creation engine 940, and the non-identifying 246 and identifying 248 attributes to be assigned to such data.

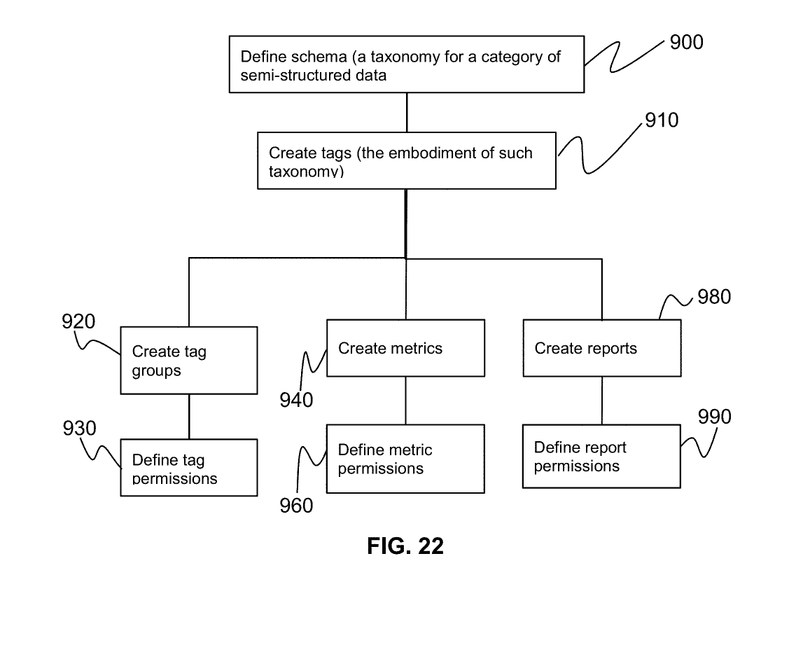

FIG. 22 illustrates another embodiment of the claimed method related to defining a class of data to be inputted and shared in credit analysis that is in substantially similar form to financial data but not specifically financial data including a set of processes for use by a non-expert user to define the schema 900 for such class of data, create the taxonomy for such schema 910, organize such taxonomy in categories 920, set permissions at the level of tags in such taxonomy 930, define metrics 940, set permissions by metric 960, create report displays 980, and set permissions for such reports 990 all without further required programming.

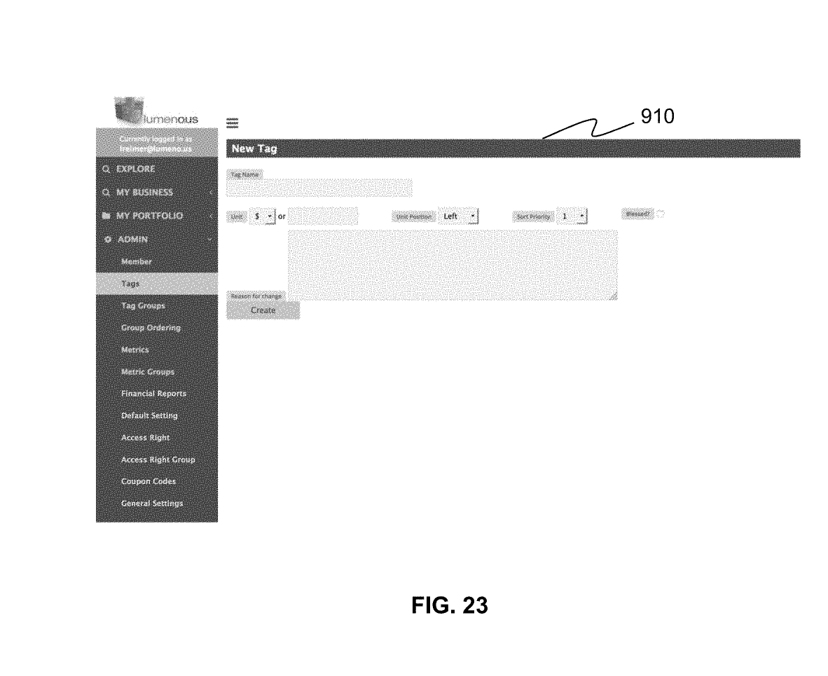

FIG. 23 illustrates the graphical user interface 320 for publishing a schema taxonomy 910. The tag can be provided a name, a unit, a unit position, the priority and whether or not the tag has been “blessed” or approved. A text box is provided the state the reason for the change for a tag.

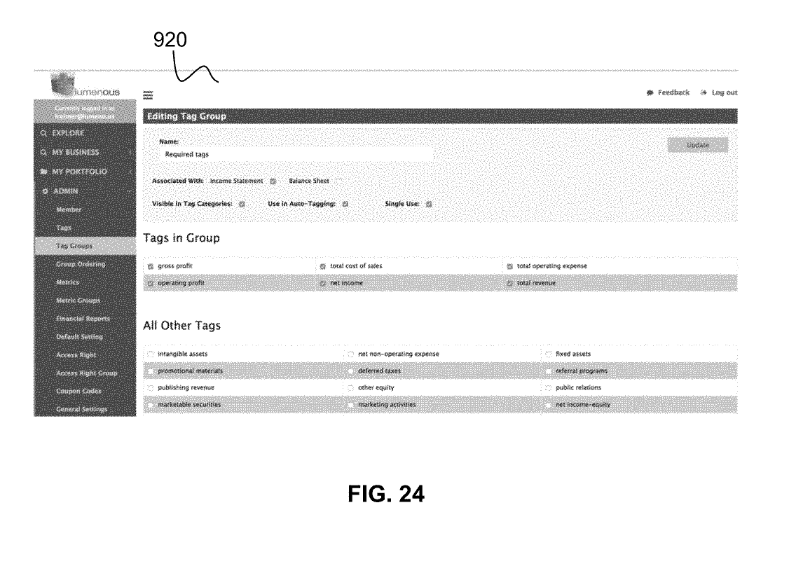

FIG. 24 illustrates the graphical user interface 320 for creating and organizing categories within a taxonomy 920. A tag group can be provided a Name, can be associated with an income statement or balance sheet, and can be visible in tag categories, used in auto-tagging, or single use. Both the Tags in the Group can be displayed as well as All Other Tags. For example, in FIG. 24, the Tag in the Group include: gross profit, operating profit, total cost of sales, net income, total operating expense, and total revenue. In FIG. 24, All Other Tags include: intangible assets, net non-operating expense, fixed assets, promotional materials, deferred taxes, referral programs, publishing revenue, other equity, public relations, marketable securities, marketing activities, and net income-equality.

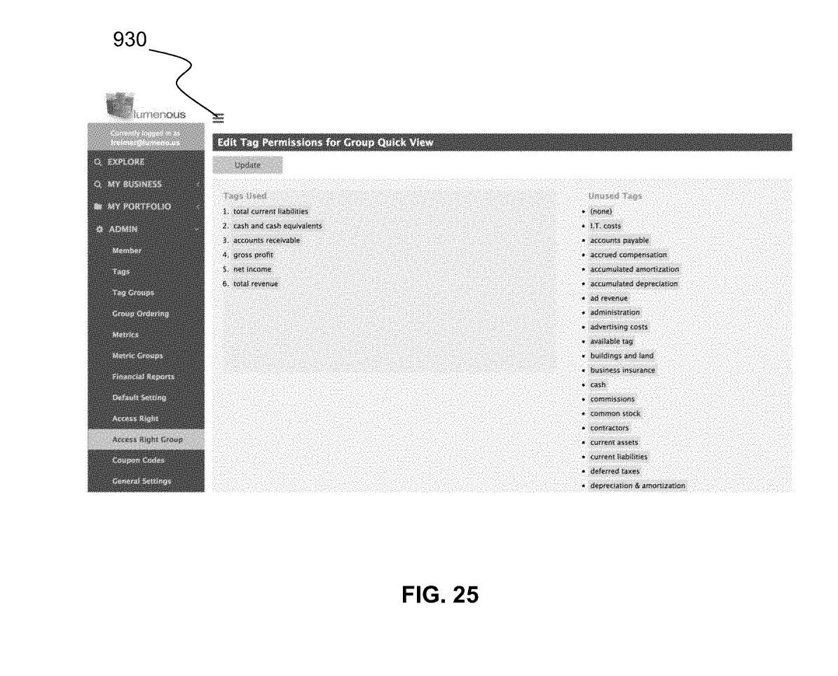

FIG. 25 illustrates the graphical user interface 320 for creating and publishing schema-related access controls 930. This view allows for editing Tag permissions for Group Quick View. The view depicts Tags used and Unused Tags. Selecting update would allow one to edit permissions for the group.

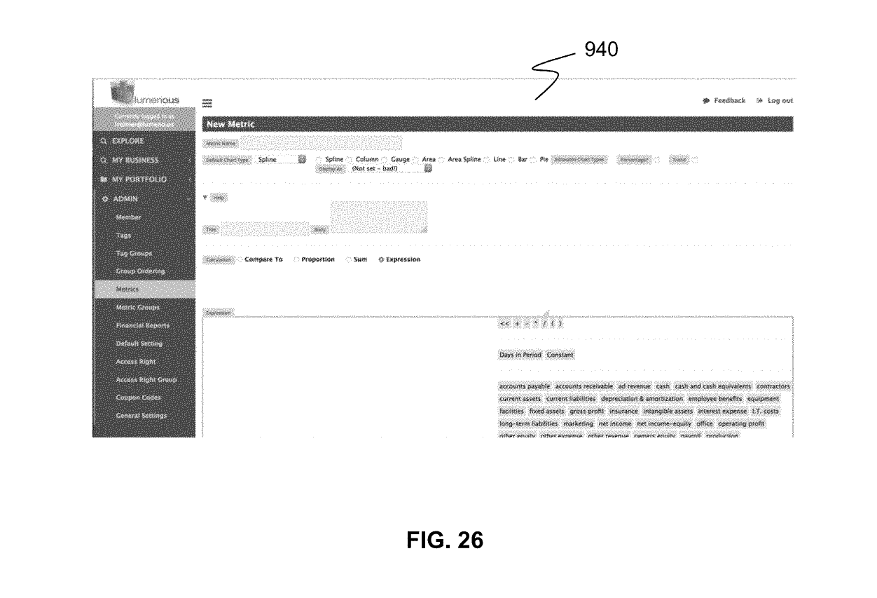

FIG. 26 illustrates the graphical user interface 320 for creating and publishing schema-related metrics 940. This view allows a user to name the metric and select the default chart type from: Spline, Column, Gauge, Area, Area Spline, Line, Bar, or Pie. A user can selected whether percentages would be displayed or trends depicted. The metric allows for editing the title and adding text to the body. The metric also allows for comparisons by selecting: Compare To, Proportion, Sum, or Expression. Finally the expression can be entered using an appropriate formula.

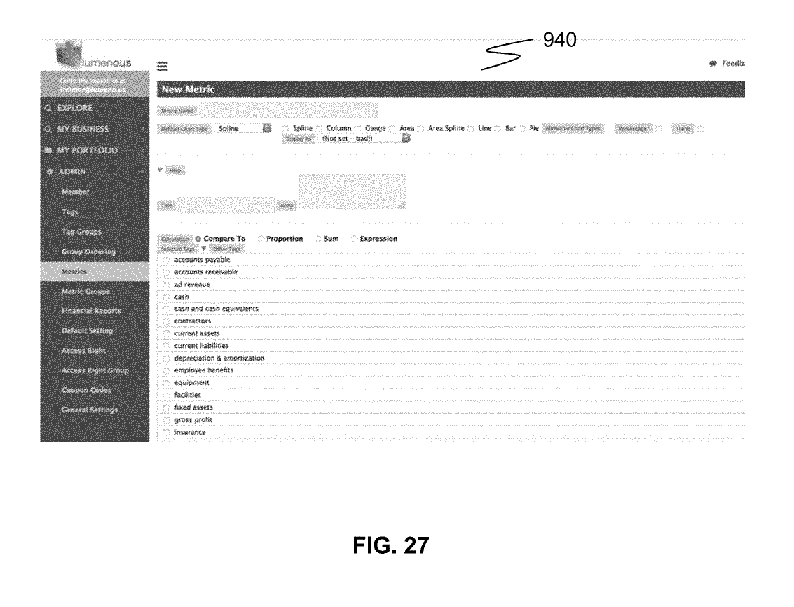

FIG. 27 illustrates another embodiment of the graphical user interface 320 for creating and publishing schema-related metrics 940. FIG. 27 further illustrates selecting several tags to apply the metric to and entering a brief description of the metric.

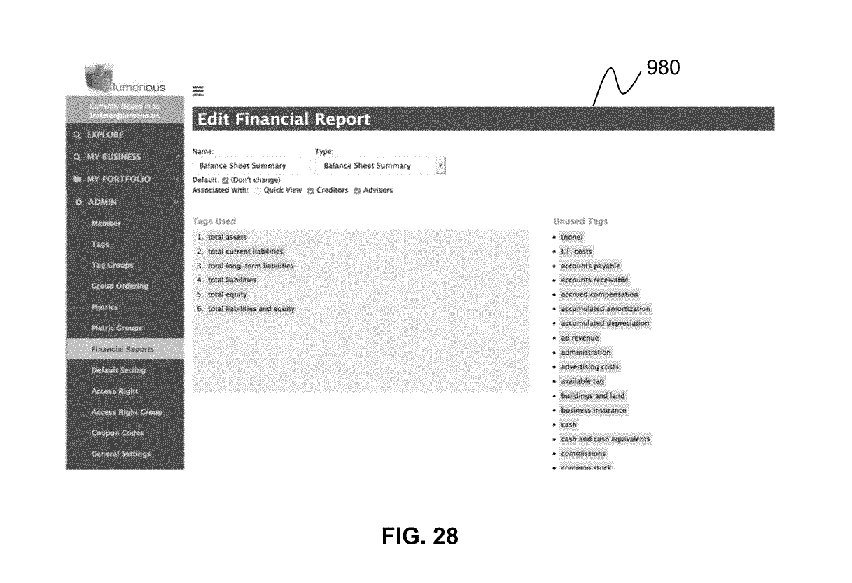

FIG. 28 illustrates the graphical user interface 320 for creating and publishing schema-related report displays 980 by assigning a caption of the display, the tags for each display, the form of display such as a table, a summary report, or a full report and the periods to be displayed such as months, quarters, or years.

The presently disclosed system also aggregates activity logs across all the member firms. This large population of users will be used to create a baseline of ‘normal’ behavior. The specific patterns of behavior of a participating firm can be compared against the larger population of users to establish a kind of social proof of their data. If for example a firm has updated their data significantly less often, has not invited as many stakeholders, or has fewer, less active discussions than their peers, their data can be identified as less reliable. Creditors can request that the firm provide more data or explain these anomalies in order to complete their evaluation. This interaction will also be logged and will contribute to computing the overall trustworthiness and accuracy of the data. More stakeholders invited into and accessing the system to view the firm's data means more likelihood that inaccuracies will be spotted and rectified. Over time, with a track record of regular updates and ongoing interactions with partners, stakeholders and creditors, the firm's data can be presumed to be accurate and the present system will assign a score relative to the normative baseline to reflect that trustworthiness.

The disclosed embodiments are susceptible to various modifications and alternative forms, and specific examples thereof have been shown by way of example in the drawings and herein described in detail. It should be understood, however, that the disclosed embodiments are not meant to be limited to the particular forms or methods disclosed, but to the contrary, the disclosed embodiments are to cover all modifications, equivalents, and alternatives.

What is claimed is:

1. A computer implemented method for self-aggregation of business information, suitable for implementation on a processor, comprising:
receiving financial and other semi-structured data via a graphical user interface into a database;
parsing the data into discrete data objects;
presenting the data in a format similar to an original source format to enable verification of accurate data; and
mapping the data to a standardized taxonomy and presenting a mapping of the data for correction and additions.

2. The computer implemented method of claim 1, wherein the processor is embodied in a cloud client.

3. The computer implemented method of claim 1, wherein the method is implemented in a cloud based environment.

4. The computer implemented method of claim 1, wherein the method is implemented in a portable electronic device, such as a tablet, notebook, desktop, smartphone, or similar device.

5. The computer implemented method of claim 1, further comprising:
applying interactive machine-learning techniques whereby at least one user assists translating data objects stored as semi-structured, non-standard financial data into a plurality of machine readable data; and
reconstituting the data objects for near real-time user queries according to a standardize-able taxonomy.

6. The computer implemented method of claim 1, wherein the parsing permits fine-grained application of interactive machine learning to the data.

7. The computer implemented method of claim 1, further comprising:
applying results from mapping activities performed by at least one user to subsequent mapping;
displaying results from continuously improved accuracy and relevance to benefit subsequent users; and
applying results from continuously improved accuracy and relevance to computer executed instruction for conducting credit analysis.

8. The computer implemented method of claim 1, further comprising mapping the user-aggregated financial and similarly structured non-financial data to schema-defined taxonomies in order to make a plurality of such data machine readable

9. The computer implemented method of claim 1, wherein the graphical user interface is specific to the series of user contributions, both explicit and implicit, that are required to accurately translate a plurality of semi-structured, non-standard data as input by a plurality of firms.

10. The computer implemented method of claim 1, wherein the graphical user interface enables a user to create and publish a taxonomy of tags that will be mapped against such semi-structured data and presented to the user for correction and approvals that further train such translation and normalization process.

11. The computer implemented method of claim 1, wherein the graphical user interface enables a non-expert user to create and publish metrics and other displays of such semi-structured data.

12. The computer implemented method of claim 1, wherein the graphical user interface enables a non-expert user to create and publish permissions for sharing such semi-structured data.

13. The computer implemented method of claim 1, further comprising formatting the data objects into a non-expert user selected semi-structured format similar to financial reports with no programming required, wherein the formatting is performed by a processor.

14. The computer implemented method of claim 1, wherein the parsing is applied to a balance sheet.

15. The computer implemented method of claim 1, wherein the parsing is applied to an income statement.

16. The computer implemented method of claim 1, wherein the parsing is applied to a cash flow statement.

17. The computer implemented method of claim 1, wherein the parsing is applied to a form containing business information substantially similar to financial reports in that numbers appear in cells and attributes for each cell are presented in text on the form.

18. The computer implemented method of claim 1, further comprising publishing by a non-expert user via a graphical user interface a schema including taxonomy, metrics, display options, and permissions to be used in parsing, translating, and normalizing user-input semi-structured data similar to the format of, but not specifically, financial data.

19. A computer implemented method for applying attributes to business information, suitable for implementation on processor, comprising:
applying source report identifiers as attributes to each data object stored on a database;
applying additional explicitly and implicitly contributed attributes to each data object initially and over time;
applying identifiable and non-identifiable attributes to each data object initially and over time; and
saving each data object according to its attributes into the database.

20. The computer implemented method of claim 19, further comprising generating access rights according to prepared templates consisting of selected attributes based on creditor-identified requirements for credit analysis.

21. The computer implemented method of claim 19, further comprising publishing via a graphical user interface, a list of attributes and data objects whereby a non-expert user may configure access rights for any number of creditors and other parties the user may invite to view credit information.

22. The computer implemented method of claim 19, further comprising publishing via a graphical user interface, a record of all previously authorized access rights whereby a non-expert user may modify level of access.

23. The computer implemented method of claim 19, further comprising generating a credit recommendation based on analysis of user-specific activity, wherein the generating is performed by a processor.

24. The computer implemented method of claim 19, further comprising generating a credit recommendation based on analysis of comparative activity, wherein the generating is performed by a processor.

25. The computer implemented method of claim 19, further comprising generating a credit recommendation based on analysis of user-specific data patterns, wherein the generating is performed by a processor.

26. The computer implemented method of claim 19, further comprising generating a credit recommendation based on analysis of comparative data patterns, wherein the generating is performed by a processor.

27. The computer implemented method of claim 19, further comprising generating a credit recommendation based on financial data aggregated according to non-identifying attributes, wherein the generating is performed by a processor.

28. The computer implemented method of claim 19, further comprising generating a plurality of system-selected metrics based on comparative activities and aggregate data, wherein the formatting is performed by a processor.

29. The computer implemented method of claim 19 wherein the processor is embodied in a cloud client.

30. The computer implemented method of claim 19 wherein the method is implemented in a cloud based environment.

31. The computer implemented method of claim 19, wherein the method is implemented in a portable electronic device, such as a tablet, notebook, desktop, smartphone, or similar device.

32. A computer implemented method for validation of business information, suitable for implementation on a processor, comprising:
associating a plurality of parsed financial data stored in a database with contextual and social information captured through a set of elements in a graphical user interface rather than by solely auditing the data itself wherein the associating is performed by a processor; and
validating the plurality of parsed financial data stored in the database by creating a plurality of baselines against which to compare the parsed financial data, wherein the validating is performed by a processor.

33. The computer implemented method of claim 32, further comprising adapting interactive machine-learning techniques to translation and normalization of data objects, both explicit and implicit, from a plurality of users in which an integrity of underlying models improves with increased number of applications of the models.

34. The computer implemented method of claim 32, further comprising prompting user contributions via the graphical user interface, wherein the graphical user interface is designed to promote incentives to engage in commercial credit analysis in which an integrity of data fidelity verification improves with increased number of applications of the analysis.

35. The computer implemented method of claim 32, wherein the graphical user interface is specific to the series of user contributions, both explicit and implicit, that are required to aggregate usage and data patterns of a plurality of users across the network that collectively accrue to inform data fidelity determinations.

36. The computer implemented method of claim 32, wherein the graphical user interface is specific to a series of user contributions, both explicit and implicit, that are required to infer degrees of fidelity of the data of a specific firm.

37. The computer implemented method of claim 32, wherein the graphical user interface is specific to a series of user contributions, both explicit and implicit, that are required to infer degrees of fidelity in the data of a specific firm as compared to collective user contributions applied against a plurality of user-inputted data.

38. The computer implemented method of claim 32, further comprising verifying the data objects by tracking a plurality of sharing activities including invitations, responses, comments and ratings and correlating such activities to patterns within any specific dataset, wherein the verifying and correlating is performed by a processor.

39. The computer implemented method of claim 32, further comprising generating a fidelity assessment based on business or non-financial data aggregated according to non-identifying attributes, wherein the generating is performed by a processor.

40. The computer implemented method of claim 32, further comprising:
verifying user-input data similar to the format of but not specifically financial data by tracking a plurality of sharing activities including invitations, responses, comments and ratings and correlating such activities to patterns within such dataset, wherein the verifying and correlating is performed by a processor; and
verifying a plurality of user-input data similar to the format of but not specifically financial data by creating a plurality of baselines against which to compare the parsed financial data, wherein the validating is performed by a processor.

41. The computer implemented method of claim 32 wherein the processor is embodied in a cloud client.

42. The computer implemented method of claim 32 wherein the method is implemented in a cloud based environment.

43. The computer implemented method of claim 32, wherein the method is implemented in a portable electronic device, such as a tablet, notebook, desktop, smartphone, or similar device.

44. A computer implemented method for self-aggregation, tagging, and validating of business information, suitable for implementation on a processor, comprising:
receiving financial and other semi-structured data via a graphical user interface by a plurality of users into a database;
saving the financial data continuously into the database;
parsing the saved financial data into a plurality of discrete data objects;
applying explicitly and implicitly contributed attributes to the data objects initially and over time;
reconstituting the data objects for real-time user queries according to a standardize-able taxonomy;
applying interactive machine-learning techniques whereby logged-in users assist the computer instructions translate data objects stored as semi-structured, non-standard financial data into a plurality of machine readable data; and
validating a plurality of parsed financial data stored in a database by associating a plurality of sharing activities with a plurality of financial data wherein the associations and inference of data fidelity is performed by the processor; and
validating a plurality of parsed financial data stored in a database by creating a plurality of baselines against which to compare the parsed financial data, wherein the inputting, saving, parsing, applying, reconstituting and validating is performed by the processor.
